(19) United States
(12) Patent Application Publication
(10) Pub. No.: US 2018/0220158 A1
(43) Pub. Date: Aug. 2, 2018

(54) METHOD AND DEVICE FOR PROCESSING VIDEO SIGNAL USING GRAPH-BASED TRANSFORM

(71) Applicant: LG Electronics Inc., Seoul (KR)

(72) Inventors: Moonmo KOO, Seoul (KR); Sehoon YEA, Seoul (KR); Kyuwoon KIM, Seoul (KR); Bumshik LEE, Seoul (KR)

(21) Appl. No.: 15/746,158

(22) PCT Filed: Jul. 21, 2016
(86) PCT No.: PCT/KR2016/007972

§ 371 Date: Jan. 19, 2018

Related U.S. Application Data
(60) Provisional application No. 62/194,819, filed on Jul. 21, 2015.

(51) Int. Cl. H04N 19/61; H04N 19/159; H04N 19/176; H04N 19/44

(52) U.S. Cl. CPC H04N 19/61; H04N 19/44; H04N 19/176; H04N 19/159

(57) ABSTRACT

A method for decoding a video signal using a graph-based transform, the method being characterized by including the steps of: parsing a transform index from the video signal; obtaining context information for a target unit, where the context information includes a prediction mode for a current block or peripheral blocks; obtaining an inverse-transform kernel on the basis of at least one of the transform index and the context information; and performing an inverse transform for the current block using the inverse transform kernel.

### TECHNICAL FIELD

The present invention relates to a method and apparatus for encoding/decoding a video signal using a graph-based transform (GBT). More particularly, the present invention relates to a graph generation method for deriving a graph-based transform applicable to an intra-coding.

### BACKGROUND ART

Compression encoding means a series of signal processing techniques for transmitting digitized information through a communication line or techniques for storing the information in a form that is proper for a storage medium. The media including a picture, an image, an audio, and the like may be the target for the compression encoding, and particularly, the technique of performing the compression encoding targeted to the picture is referred to as a video image compression

The next generation video contents are supposed to have the characteristics of high spatial resolution, high frame rate and high dimensionality of scene representation. In order to process such contents, drastic increase of memory storage, memory access rate and processing power will be resulted.

Accordingly, it is required to design the coding tool for processing the next generation video contents efficiently.

In particular, a graph is a data expression form advantageous for describing inter-pixel relation information, and a graph-based signal processing scheme of processing inter-pixel relation information by expressing it as a graph has been utilized. In such graph-based signal processing, each signal sample indicates a vertex, and the graph-based signal processing is based on a graph indicated by a graph edge in which the relations of a signal have positive weight. Different signals have quite different statistical characteristics depending on a prediction method and video content. Accordingly, it is necessary to optimize concepts, such as sampling, filtering and transform, using graph-based signal processing.

### DISCLOSURE

### Technical Problem

The present invention is to provide a method of generating a graph for deriving a graph-based transform applicable to an intra-coding.

The present invention is to provide a method of generating a graph for the entire block or a graph for a partial region in order to derive a graph-based transform applicable to an intra-coding.

The present invention is to provide a method of applying an adaptive graph-based transform to the characteristics of a video signal or a difference signal.

The present invention is to provide a method of generating a graph from split information of video and generating a transform kernel using the graph.

The present invention is to provide a method of generating an optimal transform kernel based on the graph characteristics of a difference block.

The present invention is to provide a method of selecting whether or not to apply common transform (e.g., DCT or DST) or to apply a graph-based transform by transmitting flag information for each image split unit.

The present invention is to provide a method of defining an optimal transform index corresponding to a transform kernel.

The present invention is to provide a method of generating a line graph based on at least one of edge weight, a self-loop number and self-loop weight.

The present invention is to provide a method of generating a graph-based transform kernel using line graphs of various types.

The present invention is to provide a method of defining a template for a graph-based transform based on at least one of edge weight, a self-loop number and self-loop weight and signaling the template.

### Technical Solution

The present invention provides a method of generating a graph for deriving a graph-based transform applicable to an intra-coding.

The present invention provides a method of generating a graph for the entire block or a graph for a partial region in order to derive a graph-based transform applicable to an intra-coding.

The present invention provides a method of configuring a graph for the entire block from a dependency relation with neighboring reference pixels.

The present invention provides a method of configuring a partial graph from a graph for the entire block in order to derive a graph-based transform to be applied to a local region.

The present invention provides various methods of determining a weight value of edges belonging to a graph from an intra-prediction method.

The present invention provides a method of applying an adaptive graph-based transform to the characteristics of a video signal or difference signal.

The present invention provides a method of generating a graph based on a transform unit or a prediction mode and generating a transform kernel using the graph.

The present invention provides a method of generating an optimal transform kernel based on the graph characteristics of a difference block.

The present invention provides a method of selecting whether or not to apply common transform (e.g., DCT or DST) or to apply a graph-based transform by transmitting flag information for each video split unit.

The present invention provides a method of defining an optimal transform index corresponding to a transform kernel.

The present invention provides a method of generating a line graph based on at least one of edge weight, a self-loop number and self-loop weight.

The present invention provides a method of generating a graph-based transform kernel using line graphs of various types.

### Advantageous Effects

The present invention represents a still image or a moving image in the form of a graph capable of well expressing the characteristics of a video signal and encoding/decoding the image by applying a transform kernel generated from the corresponding graph, thereby being capable of significantly reducing the amount of compressed data for a complicated image.

The present invention can improve compression efficiency in an intra-coding by deriving a graph-based transform that may be well applied to an intra-coding.

According to the present invention, a flexibility in which a transform can be adaptively applied may be secured, an operation complexity may be decreased, a faster adaptation is available for statistical property which is changed in different video segments with each other, and variability may be provided in performing a transform.

In addition, according to the present invention, more efficient coding may be performed by providing a method for applying an adaptive graph-based transform to a property of a video signal or a residual signal.

In addition, according to the present invention, an overhead in a transform matrix transmission and a transform selection may be significantly decreased by defining a transform index corresponding to an optimal transform kernel.

### DESCRIPTION OF DRAWINGS

FIG. 1 shows a schematic block diagram of an encoder for encoding a video signal, in accordance with one embodiment of the present invention.

FIG. 2 shows a schematic block diagram of a decoder for decoding a video signal, in accordance with one embodiment of the present invention.

FIGS. 3A and 3B show examples of graphs used for modeling statistical relationships in 8×8 block within a video frame according to an embodiment to which the present invention is applied.

FIGS. 4A and 4B show graphs of two shapes representing weights distribution as an embodiment to which the present invention is applied.

FIGS. 5A and 5B are diagrams for describing a procedure of obtaining a graph-based transform matrix based on 1-dimensional graph and 2-dimensional graph as an embodiment to which the present invention is applied.

FIGS. 6A to 6D are views illustrating 1-dimensional graphs which may become transform bases for applying a separable transform according to an embodiment to which the present invention is applied.

FIG. 7 is a view illustrating a method for applying a different separable transform to each line of a 2-dimension graph according to an embodiment to which the present invention is applied.

FIG. 8 is a schematic block diagram of an encoder which processes a graph-based signal according to an embodiment to which the present invention is applied.

FIG. 9 is a schematic block diagram of a decoder which processes a graph-based signal according to an embodiment to which the present invention is applied.

FIG. 10 is an internal block diagram of a graph-based transform unit according to an embodiment to which the present invention is applied.

FIG. 11 is a flowchart for illustrating a method of performing transform using a graph generated based on a transform unit size (TU size) or a prediction mode as an embodiment to which the present invention is applied.

FIG. 12 is a flowchart for illustrating a method of performing an inverse transform using a graph generated based on a transform unit size (TU size) or a prediction mode as an embodiment to which the present invention is applied.

FIG. 13 is a pixel relation diagram for illustrating a method of predicting a current pixel using an edge weight according to a prediction direction in intra-prediction as an embodiment to which the present invention is applied.

FIG. 14 is a diagram for illustrating a method of generating a graph using an edge weight according to an intra-prediction direction with respect to a 4×4 block as an embodiment to which the present invention is applied.

FIGS. 15 to 16 are diagrams for illustrating a method of generating a partial graph of a two-line unit using an edge weight according to an intra-prediction direction as embodiments to which the present invention is applied.

FIG. 17 is a diagram for illustrating a method of generating a partial graph of a one-line unit using an edge weight according to an intra-prediction direction as embodiments to which the present invention is applied.

FIG. 18 is a diagram for illustrating a method of generating a partial graph of a three-line unit using an edge weight according to an intra-prediction direction as embodiments to which the present invention is applied.

FIGS. 19 to 20 are diagrams for illustrating a method of generating a partial graph of a two-line unit using an edge weight according to a vertical direction in intra-prediction as embodiments to which the present invention is applied.

FIGS. 21 to 22 are diagram for illustrating a method of generating a partial graph of a two-line unit using an edge weight according to a bottom right direction in intra-prediction as embodiments to which the present invention is applied.

FIG. 23 is a flowchart for illustrating a method of calculating an edge weight according to a prediction mode and generating a line graph based on the edge weight as an embodiment to which the present invention is applied.

### BEST MODE

The present invention provides a method for decoding a video signal using a graph-based transform, including the steps of parsing a transform index from the video signal; obtaining context information for a target unit, wherein the context information includes a prediction mode for a current block or a neighboring block; obtaining an inverse transform kernel based on at least one of the transform index and the context information; and performing an inverse transform on the current block using the inverse transform kernel.

In the present invention, the inverse transform kernel has been generated based on a line graph expressed by an edge weight of the current block, and the edge weight is calculated using a prediction direction angle corresponding to the prediction mode for the current block or the neighboring block.

In the present invention, the prediction direction angle indicates an angle formed by a prediction direction and a horizontal axis, and the edge weight indicates a cosine value for the angle.

In the present invention, the edge weight is calculated by at least one of a minimum value, summation, multiplication and an average value of connected edge weights.

In the present invention, the line graph includes a partial graph of at least one line unit.

In the present invention, if the line graph indicates a partial graph of one line, the transform kernel indicates 1D separable graph-based transform corresponding to the line graph.

The present invention provides a method for encoding a video signal using a graph-based transform, including the steps of checking context information for a current block, wherein the context information includes a prediction mode for the current block or a neighboring block; calculating an edge weight between pixels within the current block using a prediction direction angle corresponding to the prediction mode for the current block or the neighboring block; deriving a transform kernel from a line graph generated based on the edge weight; and performing transform for the current block using the transform kernel.

In the present invention, the method further includes the step of encoding a transform index corresponding to the transform kernel.

In the present invention, the edge weight is calculated using a weight function set based on the prediction mode or the prediction direction angle.

In the present invention, the prediction direction angle indicates an angle formed by a prediction direction and a horizontal axis, and the edge weight indicates a cosine value for the angle.

In the present invention, the edge weight is calculated by at least one of a minimum value, summation, multiplication and an average value of connected edge weights.

In the present invention, the line graph includes a partial graph of at least one line unit.

In the present invention, if the line graph indicates a partial graph of one line, the transform kernel indicates 1D separable graph-based transform corresponding to the line graph.

The present invention provides an apparatus for encoding a video signal using a graph-based transform, including a graph signal generation unit checking context information for a current block and calculating an edge weight between pixels within the current block using a prediction direction angle corresponding to the prediction mode for the current block or the neighboring block; a transform matrix determination unit deriving a transform kernel from a line graph generated based on the edge weight; and a transform execution unit performing transform for the current block using the transform kernel, wherein the context information includes a prediction mode for the current block or a neighboring block.

The present invention provides an apparatus for decoding a video signal using a graph-based transform, including a parsing unit parsing a transform index from the video signal; and an inverse transform unit obtaining context information for a target unit, obtaining an inverse transform kernel based on at least one of the transform index and the context information, and performing an inverse transform on the current block using the inverse transform kernel, wherein the context information includes a prediction mode for a current block or a neighboring block.

### MODE FOR INVENTION

Hereinafter, exemplary elements and operations in accordance with embodiments of the present invention are described with reference to the accompanying drawings, however, it is to be noted that the elements and operations of the present invention described with reference to the drawings are provided as only embodiments and the technical spirit and kernel configuration and operation of the present invention are not limited thereto.

Furthermore, terms used in this specification are common terms that are Furthermore, terms used in this specification are common terms that are now widely used, but in special cases, terms randomly selected by the applicant are used. In such a case, the meaning of a corresponding term is clearly described in the detailed description of a corresponding part. Accordingly, it is to be noted that the present invention should not be construed as being based on only the name of a term used in a corresponding description of this specification and that the present invention should be construed by checking even the meaning of a corresponding term.

Furthermore, terms used in this specification are common terms selected to describe the invention, but may be replaced with other terms for more appropriate analysis if such terms having similar meanings are present. For example, a signal, data, a sample, a picture, a frame, and a block may be properly replaced and interpreted in each coding process. Furthermore, partitioning, decomposition, splitting, division may also be properly replaced and interpreted in each coding process.

By applying a linear transform that adaptively modifies the statistical properties of a signal in different parts of a video sequence, compression efficiency may be improved. General statistical methods have been tried such an object, but they bring a restricted result. The present invention introduces a graph-based signal processing technique as a more efficient method for modeling statistical properties of a video signal for video compression.

In order to simplify mathematical analysis and to use the result known from a graph theory, most of applications developed for the graph-based signal processing uses an undirected graph without self-loop (i.e., there is no edge that connects nodes in itself), and models with non-negative edge only in each graph edge.

Such an approach may be successfully applied for signaling an image of well defined discontinuity, sharp edge or a depth image. The graphs corresponding to N² pixel blocks in an image and video application require transmission overhead for 2N² or 4N² non-negative edge weights, generally. After a graph is defined, the orthogonal transform for coding or prediction may be derived by calculating Eigen decomposition of a graph Laplacian matrix. For example, through the spectral decomposition, an Eigenvector and an Eigen value may be obtained.

The present invention provides a method of generating a graph-based transform kernel by combining transform coefficients of a region split based on an edge in a partial graph of at least one line unit. In this case, transform obtained from the graph may be defined as a graph-based transform (hereinafter referred to as “GBT”). For example, assuming that relation information between pixels forming a TU is expressed in a graph form, transform obtained from the graph may be called GBT.

Hereinafter, embodiments to which the present invention is applied are described in detail.

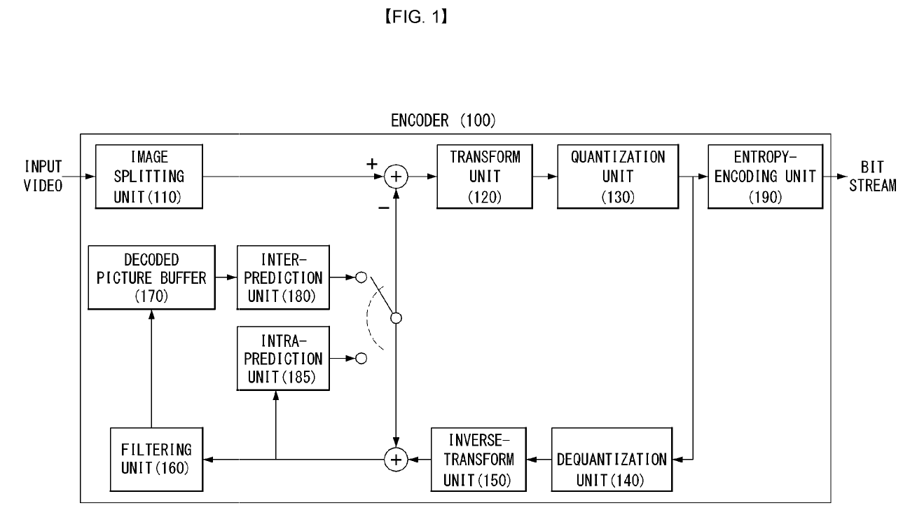

FIG. 1 shows a schematic block diagram of an encoder for encoding a video signal, in accordance with one embodiment of the present invention.

Referring to FIG. 1, an encoder 100 may include an image segmentation unit 110, a transform unit 120, a quantization unit 130, an inverse quantization unit 140, an inverse transform unit 150, a filtering unit 160, a DPB (Decoded Picture Buffer) 170, an inter-prediction unit 180, an intra-prediction unit 185 and an entropy-encoding unit 190.

The image segmentation unit 110 may divide an input image (or, a picture, a frame) input to the encoder 100 into one or more process units. For example, the process unit may be a coding tree unit (CTU), a coding unit (CU), a prediction unit (PU), or a transform unit (TU).

However, the terms are used only for convenience of illustration of the present disclosure. The present invention is not limited to the definitions of the terms. In this specification, for convenience of illustration, the term “coding unit” is employed as a unit used in a process of encoding or decoding a video signal. However, the present invention is not limited thereto. Another process unit may be appropriately selected based on contents of the present disclosure.

The encoder 100 may generate a residual signal by subtracting a prediction signal output from the inter-prediction unit 180 or intra prediction unit 185 from the input image signal. The generated residual signal may be transmitted to the transform unit 120.

The transform unit 120 may apply a transform technique to the residual signal to produce a transform coefficient. The transform process may be applied to a pixel block having the same size of a square, or to a block of a variable size other than a square.

The quantization unit 130 may quantize the transform coefficient and transmits the quantized coefficient to the entropy-encoding unit 190. The entropy-encoding unit 190 may entropy-code the quantized signal and then output the entropy-coded signal as bitstreams.

The quantized signal output from the quantization unit 130 may be used to generate a prediction signal. For example, the quantized signal may be subjected to an inverse quantization and an inverse transform via the inverse quantization unit 140 and the inverse transform unit 150 in the loop respectively to reconstruct a residual signal. The reconstructed residual signal may be added to the prediction signal output from the inter-prediction unit 180 or intra-prediction unit 185 to generate a reconstructed signal.

On the other hand, in the compression process, adjacent blocks may be quantized by different quantization parameters, so that deterioration of the block boundary may occur. This phenomenon is called blocking artifacts. This is one of important factors for evaluating image quality. A filtering process may be performed to reduce such deterioration. Using the filtering process, the blocking deterioration may be eliminated, and, at the same time, an error of a current picture may be reduced, thereby improving the image quality.

The filtering unit 160 may apply filtering to the reconstructed signal and then outputs the filtered reconstructed signal to a reproducing device or the decoded picture buffer 170. The filtered signal transmitted to the decoded picture buffer 170 may be used as a reference picture in the inter-prediction unit 180. In this way, using the filtered picture as the reference picture in the inter-picture prediction mode, not only the picture quality but also the coding efficiency may be improved.

The decoded picture buffer 170 may store the filtered picture for use as the reference picture in the inter-prediction unit 180.

The inter-prediction unit 180 may perform temporal prediction and/or spatial prediction with reference to the reconstructed picture to remove temporal redundancy and/or spatial redundancy. In this case, the reference picture used for the prediction may be a transformed signal obtained via the quantization and inverse quantization on a block basis in the previous encoding/decoding. Thus, this may result in blocking artifacts or ringing artifacts.

Accordingly, in order to solve the performance degradation due to the discontinuity or quantization of the signal, the inter-prediction unit 180 may interpolate signals between pixels on a subpixel basis using a low-pass filter. In this case, the subpixel may mean a virtual pixel generated by applying an interpolation filter. An integer pixel means an actual pixel existing in the reconstructed picture. The interpolation method may include linear interpolation, bi-linear interpolation and Wiener filter, etc.

The interpolation filter may be applied to the reconstructed picture to improve the accuracy of the prediction. For example, the inter-prediction unit 180 may apply the interpolation filter to integer pixels to generate interpolated pixels. The inter-prediction unit 180 may perform prediction using an interpolated block composed of the interpolated pixels as a prediction block.

The intra-prediction unit 185 may predict a current block by referring to samples in the vicinity of a block to be encoded currently. The intra-prediction unit 185 may perform a following procedure to perform intra prediction. First, the intra-prediction unit 185 may prepare reference samples needed to generate a prediction signal. Then, the intra-prediction unit 185 may generate the prediction signal using the prepared reference samples. Thereafter, the intra-prediction unit 185 may encode a prediction mode. At this time, reference samples may be prepared through reference sample padding and/or reference sample filtering. Since the reference samples have undergone the prediction and reconstruction process, a quantization error may exist. Therefore, in order to reduce such errors, a reference sample filtering process may be performed for each prediction mode used for intra-prediction

The prediction signal generated via the inter-prediction unit 180 or the intra-prediction unit 185 may be used to generate the reconstructed signal or used to generate the residual signal.

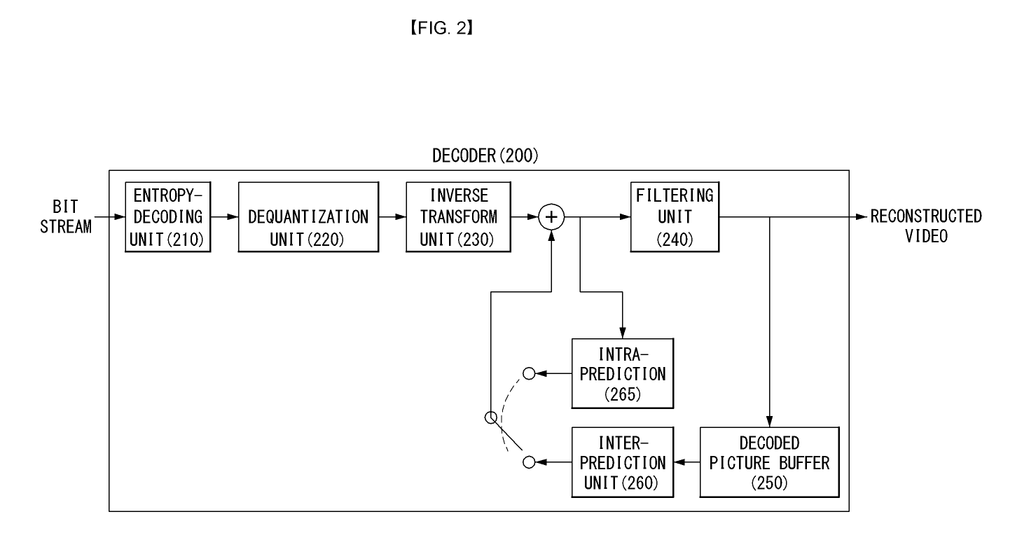

FIG. 2 shows a schematic block diagram of a decoder for decoding a video signal, in accordance with one embodiment of the present invention.

Referring to FIG. 2, a decoder 200 may include a parsing unit (not shown), an entropy-decoding unit 210, an inverse quantization unit 220, an inverse transform unit 230, a filtering unit 240, a decoded picture buffer (DPB) 250, an inter-prediction unit 260 and an intra-prediction unit 265.

A reconstructed video signal output from the decoder 200 may be reproduced using a reproducing device.

The decoder 200 may receive the signal output from the encoder as shown in FIG. 1. The received signal may be entropy-decoded via the entropy-decoding unit 210.

The inverse quantization unit 220 may obtain a transform coefficient from the entropy-decoded signal using quantization step size information. In this case, the obtained transform coefficient may be associated with the operations of the transform unit 120 as described above with reference to FIG. 1.

The inverse transform unit 230 may inverse-transform the transform coefficient to obtain a residual signal.

A reconstructed signal may be generated by adding the obtained residual signal to the prediction signal output from the inter-prediction unit 260 or the intra-prediction unit 265.

The filtering unit 240 may apply filtering to the reconstructed signal and may output the filtered reconstructed signal to the reproducing device or the decoded picture buffer unit 250. The filtered signal transmitted to the decoded picture buffer unit 250 may be used as a reference picture in the inter-prediction unit 260.

Herein, detailed descriptions for the filtering unit 160, the inter-prediction unit 180 and the intra-prediction unit 185 of the encoder 100 may be equally applied to the filtering unit 240, the inter-prediction unit 260 and the intra-prediction unit 265 of the decoder 200 respectively.

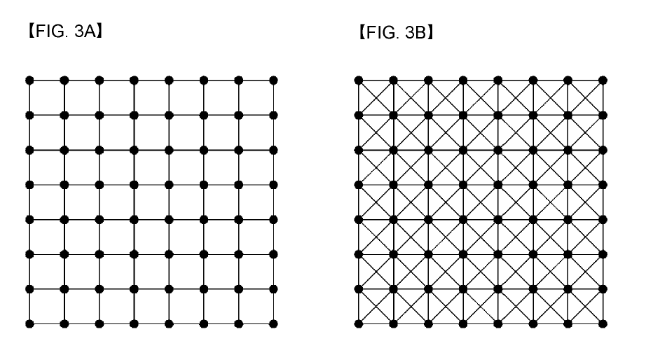

FIGS. 3A and 3B show examples of graphs used for modeling statistical relationships in 8×8 block within a video frame according to an embodiment to which the present invention is applied.

The discrete-time signal processing technique has been developed from directly processing and filtering an analogue signal, and accordingly, has been restricted by a few common assumptions such as sampling and processing regularly organized data only.

Basically, the video compression field is based on the same assumption, but has been generalized for a multi-dimensional signal. The signal processing based on a graph representation generalizes the concepts such as sampling, filtering and Fourier transform, uses the graph that represents a vertex by each signal sample, and is started from the conventional approach in which signal relationships are represented by graph edges with positive weights. This completely isolates a signal from its acquisition process, and accordingly, the properties such as sampling rate and sequence are completely replaced by the properties of a graph. Accordingly, the graph representation may be defined by a few specific graph models.

In the present invention, an undirected simple graph and an undirected edge may be used to represent an empirical connection between data values. Here, the undirected simple graph may mean a graph without self-loop or multiple edges.

When the undirected simple graph that has a weight allocated for each edge is referred to as G, the undirected simple graph G may be described with triplet as represented in Equation 1.

G={v,ε,w} [Equation 1]

Here, V represents V numbers of graph vertex set, ε represents a graph edge set, and W represents a weight represented as V×V matrix. Here, weight W may be represented as Equation 2 below.

W_{i,j}=W_{j,i}≥0 [Equation 2]

W_{i,j} represents a weight of edge (i, j), and W_{j,i} represents a weight of edge (j, i). When there is no edge connecting vertex (i, j), W_{i,j}=0. For example, in the case of assuming that there is no self-loop, W_{i,i}=0, always.

The representation is partially overlapped for a special case of the undirected simple graphs that have an edge weight. This is because matrix W includes all types of information of the graph. Accordingly, in the present invention, hereinafter, a graph is represented as G(W).

Meanwhile, referring to FIGS. 3A and 3B, the present invention provides two embodiments of graph types that may be used for processing 8×8 pixel blocks in an image or a video. Each pixel is in relation to a graph vertex, and the pixel value becomes the value of the graph vertex.

A graph edge may mean a line connecting graph vertexes. The graph edge is used for representing a certain type of statistical dependency within a signal, and in this case, a positive weigh may represent the sharpness. For example, each vertex may be connected to all of other vertexes, and weight of 0 may be allocated to an edge that connects vertexes not coupled with each other or weakly coupled. However, for simplifying the representation, the edge having the weight of 0 may be completely removed.

In the graph shown in FIG. 3A, a graph edge may be defined such that each vertex is connected to the nearest 4 adjacent vertexes. However, a block edge may be differently treated. In addition, in the graph shown in FIG. 3B, it may be defined that each vertex is connected to the nearest 8 adjacent vertexes.

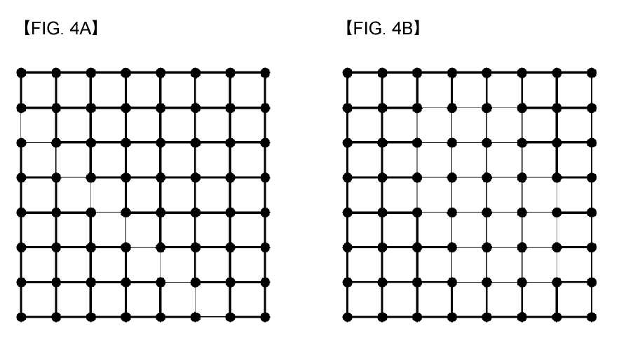

FIGS. 4A and 4B show graphs of two shapes representing weights distribution as an embodiment to which the present invention is applied.

The vertex value of a graph is an independent variable based on a signal measurement (normally, modeled as an arbitrary variable), but it is required to select an edge weight in accordance with the property of a part of signal. FIGS. 4A and 4B show two exemplary graphs that represent the edge weights of different lines for a graph edge. For example, the bold lines may represent the weight of w=1, and the fine lines may represent the weight of w=0.2.

The graph shown in FIG. 4A represents the case of having “weak link” along a straight line, and represents the case of having two types of edge weights only. Here, the “weak link” means having relatively small edge weight.

This is commonly used in a graph-based image processing actually, and such a construction may represent a difference between an edge in an image and a pixel statistics between different sides.

FIG. 4B represents a distribution of an edge weight that covers irregular area. The present invention is to provide a method for processing a signal using such a distribution graph of an edge weight.

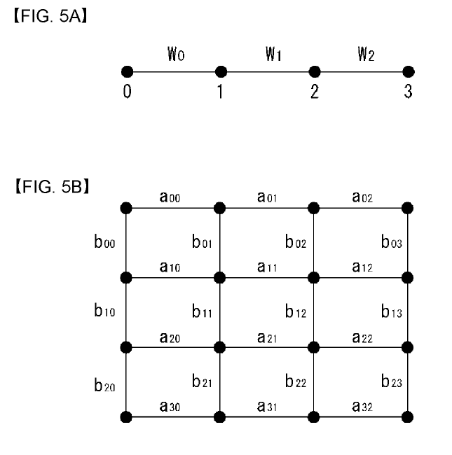

FIGS. 5A and 5B are diagrams for describing a procedure of obtaining a graph-based transform matrix based on 1-dimensional graph and 2-dimensional graph as an embodiment to which the present invention is applied.

As an embodiment of the present invention, the graph type that may be used for processing a pixel block in an image may be described using FIGS. 5A and 5B. For example, FIG. 5A shows 1-dimensional graph that corresponds to each line in the pixel block, and FIG. 5B shows 2-dimensional graph that corresponds to the pixel block.

A graph vertex is in relation to each pixel of the pixel block, and a value of the graph vertex may be represented as a pixel value. And, a graph edge may mean a line connecting the graph vertexes. The graph edge is used for representing a certain type of statistical dependency in a signal, and the value representing its sharpness may be referred to as an edge weight.

For example, FIG. 5A shows a 1-dimensional graph, 0, 1, 2 and 3 represents the position of each vertex, and w₀, w₁ and w₂ represent the edge weight between vertexes. FIG. 5B shows a 2-dimensional graph, and aᵢⱼ (i=0, 1, 2, 3, j=0, 1, 2) and bₖₗ (k=0, 1, 2, l=0, 1, 2, 3) represent the edge weight between vertexes.

Each vertex may be connected to all of other vertexes, and weight of 0 may be allocated to an edge that connects vertexes not coupled with each other or weakly coupled. However, for simplifying the representation, the edge having the weight of 0 may be completely removed.

The relationship information between pixels may be represented as whether there is an edge between pixels and an edge weight when each pixel is mapped to a vertex of a graph.

In this case, GBT may be obtained through the following procedures. For example, an encoder or a decoder may obtain graph information from a target block of a video signal. From the obtained graph information, Laplacian matrix L may be obtained as represented in Equation 3 below.

L=D−A [Equation 3]

In Equation 3 above, D represents a degree matrix. For example, the degree matrix may mean a diagonal matrix including the information of a degree of each vertex. A represents an adjacency matrix that represents the interconnection (for example, edge) with an adjacent pixel by a weight.

And, with respect to the Laplacian matrix L, a GBT kernel may be obtained by performing an Eigen decomposition as represented in Equation 4 below.

L=U∧U^{T} [Equation 4]

In Equation 4 above, L means a Laplacian matrix L, U means an Eigen matrix, and U^{T} means a transposed matrix of U. In Equation 4, the Eigen matrix U may provide a graph-based Fourier transform specialized for a signal suitable for the corresponding model. For example, the Eigen matrix U that satisfies Equation 4 may mean a GBT kernel.

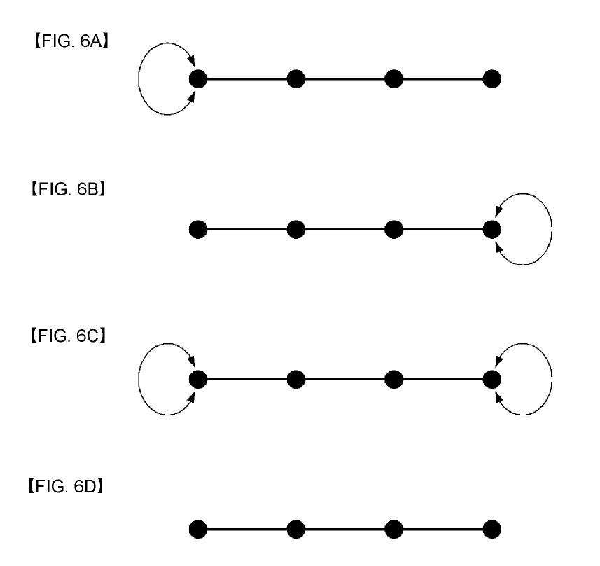

FIGS. 6A to 6D are views illustrating 1-dimensional (1D) graphs which may become transform bases for applying a separable transform according to an embodiment to which the present invention is applied.

Embodiments regarding 1D graphs which may become a base for one line may be described as follows.

In a first embodiment, correlation regarding one pixel pair is so small that a weight value of a corresponding edge may be set to be small. For example, a pixel pair including a block boundary may have relatively small correlation, so a small edge weight may be set for a graph edge including a block boundary.

In a second embodiment, a self-loop may be present or not at both ends, or self-loop may be present only at one end. For example, FIGS. 6A and 6B illustrate the case where the self-loop is present only at one of both ends, FIG. 6C illustrates the case where the self-loop is present at both ends of the graph, and FIG. 6D illustrates the case where the self-loop is not present at both ends of the graph. Here, the self-loop, representing dependency with an adjacent vertex, may refer to self-weight, for example. That is, a weight may be further given to a portion where the self-loop is present.

In another embodiment of the present invention, an extra 1D separable transform set may be defined according to TU sizes. In the case of non-separable transform, transform coefficient data is increased to O(N⁴) as a TU size is increased, but in the case of the separable transform, the transform coefficient data is increased to O(N²). Thus, the following configuration may be formed by combining several 1D separable transforms forming a base.

For example, as a 1D separable transform template, a template in which the self-loop is present on the left as illustrated in FIG. 6A, a template in which the self-loop is present on the right as illustrated in FIG. 6B, a template in which the self-loop is present at both ends as illustrated in FIG. 6C, and a template in which the self-loop is not present on both sides as illustrated in FIG. 6D, may be provided. When these templates are all available, the four cases may be possible in rows and columns, and thus, template indices for a total of 16 combinations may be defined.

In another embodiment, in case where a partition boundary or an object boundary is present in the middle of a TU, a template index may be signaled and a separate template in which a small weight value is additionally given only to an edge corresponding to a boundary may be applied instead.

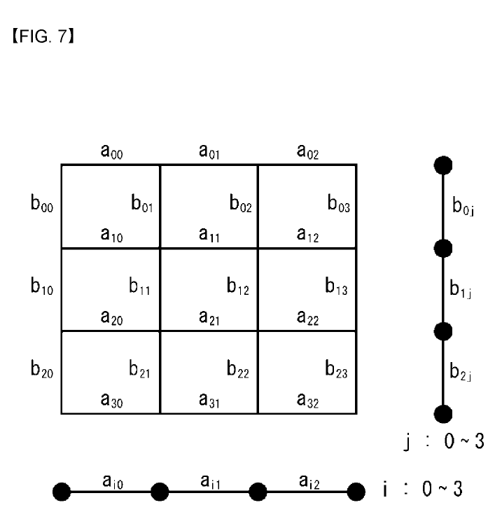

FIG. 7 is a view illustrating a method for applying a different separable transform to each line of a 2-dimensional (2D) graph according to an embodiment to which the present invention is applied.

FIG. 7 illustrates 2D graph corresponding to a pixel block, in which a graph vertex is associated with each pixel of the pixel block, and a value of the graph vertex may be expressed as a pixel value. Here, the line connecting the graph vertices refers to a graph edge. As discussed above, the graph edge is used to indicate statistical dependency in a certain form within a signal, and a value indicating strength thereof may be called an edge weight. For example, referring to FIG. 7, a 2D graph is illustrated in which aᵢⱼ (i=0, 1, 2, 3, j=0, 1, 2), bₖₗ (k=0, 1, 2, l=0, 1, 2, 3) indicate an edge weight between vertices.

In an embodiment to which the present invention is applied, in the case of a 2D graph connecting graph edges only for pixels neighboring in a right angle direction (which may also be called a 4-connected graph), 2D NSGBT (non-separable GBT) may be applied but a 1D SGBT (separable GBT) may be applied to a row direction and a column direction.

For example, since each vertex of the 2D graph of FIG. 7 has a maximum of four neighboring vertices, the graph may be a 4-connected graph, and here, a 2D NSGBT (non-separable GBT) kernel may be generated and applied by using an edge weight (aᵢⱼ, bₖₗ) of each side.

In a specific example, in the row direction, 1D SGBT (separable GBT) for the graph including edge weights of aᵢ₀, aᵢ₁, aᵢ₂ of an ith row is applied to each column, and regarding each column, 1D SGBT (separable GBT) regarding a graph including edge weights of b₀ⱼ, b₁ⱼ, b₂ⱼ of a jth column may be applied to each row.

In another example, in the case of an arbitrary 4-connected graph, different 1D SGBT (separable GBT) may be applied to each line (in both a horizontal direction and a vertical direction). For example, in case where combinations of edge weights for each of column and row are different in FIG. 7, 1D SGBT for each combination may be applied.

Meanwhile, in case where a GBT template set for a N×N TU includes M number of 4-connected graphs, a total of M number of N²×N² transform matrices should be prepared, increasing a memory demand for storing the transform matrices. Thus, if one 4-connected graph can be combined to at least one 1D graph element so as to be configured, only transform for the at least one 1D graph element is required, and thus, a memory amount for storing the transform matrices may be reduced.

In an embodiment of the present invention, various 4-connected 2D graphs may be generated by a limited number of 1D graph elements, whereby a GBT template set appropriate for each mode combination may be customized. Although a total number of GBT templates is increased, the number of 1D transforms forming the base may remain as is, and thus, a required amount of memory may be minimized. For example, combinations of a limited number of (aᵢ₀, aᵢ₁, aᵢ₂) and (b₀ⱼ, b₁ⱼ, b₂ⱼ) may be prepared and appropriately connected in units of 1D graphs for each combination to generate one 4-connected 2D graph.

For example, regarding a current coding block, if graph edge information, partition information, inter-pixel correlation information, and the like, can be received from a bit stream or derived from surrounding information, combinations of 1D transforms may be customized using these information.

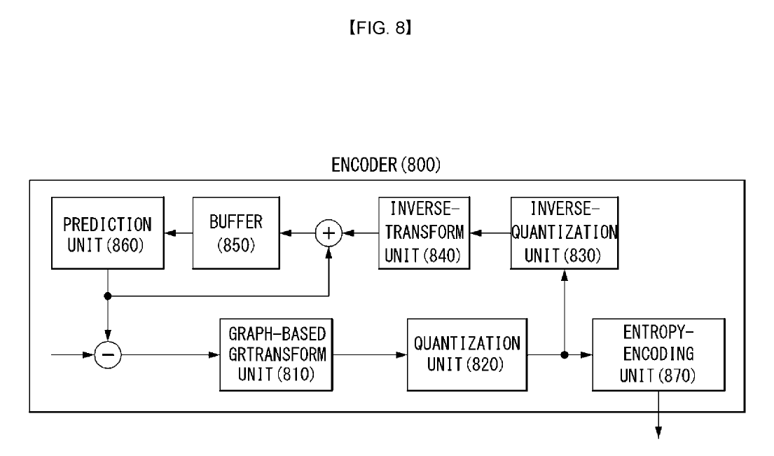

FIG. 8 is a schematic block diagram of an encoder which processes a graph-based signal according to an embodiment to which the present invention is applied.

Referring to FIG. 8, an encoder 800 to which the present invention is applied includes a graph-based transform unit 810, a quantization unit 820, a transform-quantization unit 830, an inverse-transform unit 840, a buffer 850, a prediction unit 860, and an entropy-encoding unit 870.

The encoder 800 receives a video signal and subtracts a predicted signal output from the prediction unit 860 from the video signal to generate a prediction error. The generated prediction error is transmitted to the graph-based transform unit 810, and the graph-based transform unit 810 generates a transform coefficient by applying a transform scheme to the prediction error.

In another embodiment to which the present invention is applied, the graph-based transform unit 810 may compare an obtained graph-based transform matrix with the transform matrix obtained from the transform unit 120 of FIG. 1 and select a more appropriate transform matrix.

The quantization unit 820 quantizes the generated transform coefficient and transmits the quantized coefficient to the entropy-encoding unit 820.

The entropy-encoding unit 820 performs entropy encoding on the quantized signal and outputs an entropy-coded signal.

The quantized signal output from the quantization unit 820 may be used to generate a predicted signal. For example, the inverse-quantization unit 830 within the loop of the encoder 800 and the inverse-transform unit 840 may perform inverse-quantization and inverse-transform on the quantized signal such that the quantized signal may be reconstructed to a prediction error. The reconstructed signal may be generated by adding the reconstructed prediction error to the predicted signal output from the prediction unit 860.

The buffer 850 stores a reconstructed signal for a future reference of the prediction unit 860.

The prediction unit 860 may generate a predicted signal using a signal which was previously reconstructed and stored in the buffer 850. The generated predicted signal is subtracted from the original video signal to generate a residual signal, and the residual signal is transmitted to the graph-based transform unit 810.

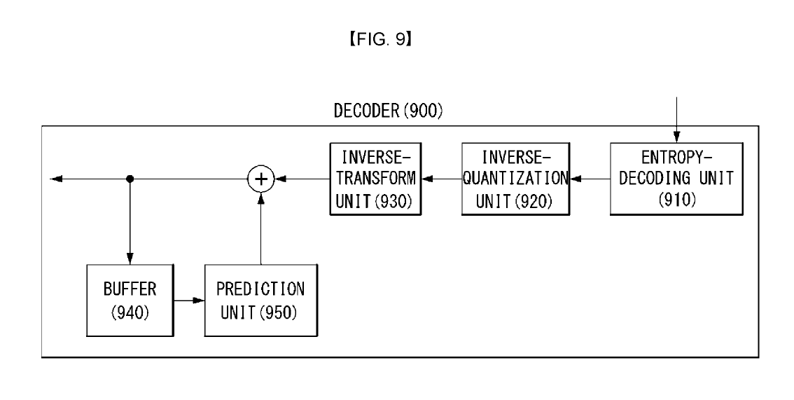

FIG. 9 is a schematic block diagram of a decoder which processes a graph-based signal according to an embodiment to which the present invention is applied.

A decoder 900 of FIG. 9 receives a signal output from the encoder 800 of FIG. 8.

An entropy decoding unit 910 performs entropy-decoding on a received signal. The inverse-quantization unit 920 obtains a transform coefficient from the entropy-decoded signal based on a quantization step size.

The inverse-transform unit 930 performs inverse-transform on a transform coefficient to obtain a residual signal. Here, the inverse-transform may refer to inverse-transform for graph-based transform obtained from the encoder 800.

The obtained residual signal may be added to the predicted signal output from the prediction unit 950 to generate a reconstructed signal.

The buffer 940 may store the reconstructed signal for future reference of the prediction unit 950.

The prediction unit 950 may generate a predicted signal based on a signal which was previously reconstructed and stored in the buffer 940.

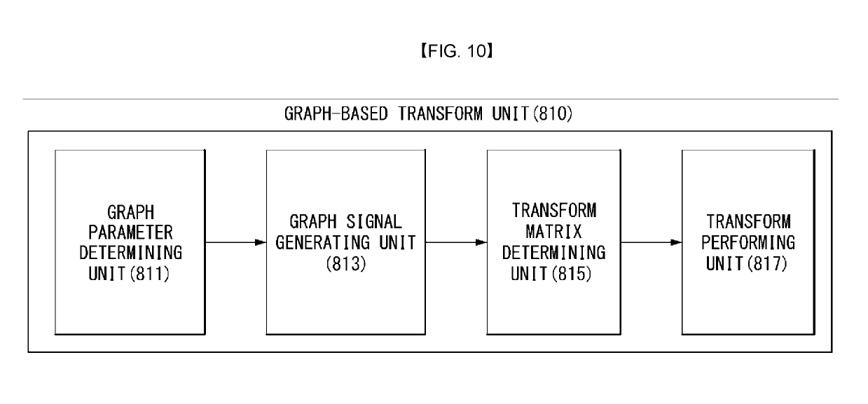

FIG. 10 is an internal block diagram of a graph-based transform unit according to an embodiment to which the present invention is applied.

Referring to FIG. 10, the graph-based transform unit 810 may include a graph parameter determining unit 811, a graph signal generating unit 813, a transform matrix determining unit 815, and a transform performing unit 817.

The graph parameter determining unit 811 may extract a graph parameter of a graph corresponding to a target unit of a video signal or a residual signal. For example, the graph parameter may include at least one of a vertex parameter and an edge parameter. The vertex parameter may include at least one of a vertex position and the number of vertices, and the edge parameter may include at least one of an edge weight value and the number of edge weights. Also, the graph parameter may be defined to a predetermined number of sets.

For another example, the edge parameter may include boundary information. The boundary information may include at least one of edge weight, a self-loop number and self-loop weight. In this case, the self-loop number may mean the number of self-loops or the location of self-loops. In this specification, the self-loop number has been described, but may be substituted with a self-loop location and expressed.

According to an embodiment of the present invention, a graph parameter extracted from the graph parameter determining unit 811 may be expressed as a generalized form.

The graph signal generating unit 813 may generate a graph signal based on a graph parameter extracted from the graph parameter determining unit 811. Here, the graph signal may include a line graph to which a weight is applied or a weight is not applied. The line graph may be generated for each of a row or column of a target block.

The transform matrix determining unit 815 may determine a transform matrix appropriate for the graph signal. For example, the transform matrix may be determined based on rate distortion (RD) performance. Also, in this disclosure, the transform matrix may be replaced with an expression of transform or a transform kernel so as to be used.

In an embodiment of the present invention, the transform matrix may be a value already determined in the encoder or the decoder, and here, the transform matrix determining unit 815 may be derived from a place where the transform matrix appropriate for the graph signal is stored.

In another embodiment of the present invention, the transform matrix determining unit 815 may generate a 1D transform kernel for a line graph, and generate a 2D separable graph-based transform kernel by combining two of 1D transform kernels. The transform matrix determining unit 815 may determine a transform kernel appropriate for the graph signal among the 2D separable graph-based transform kernels based on the RD performance.

The transform performing unit 817 may perform transform using the transform matrix obtained from the transform matrix determining unit 815.

In this disclosure, functions are sub-divided and described to describe a process of performing graph-based transform, but the present invention is not limited thereto. For example, the graph-based transform unit 810 may include a graph signal generating unit and a transform unit, and here, a function of the graph parameter determining unit 811 may be performed in the graph signal generating unit, and functions of the transform matrix determining unit 815 and the transform performing unit 817 may be performed in the transform unit. Also, a function of the transform unit may be divided into a transform matrix determining unit and a transform performing unit.

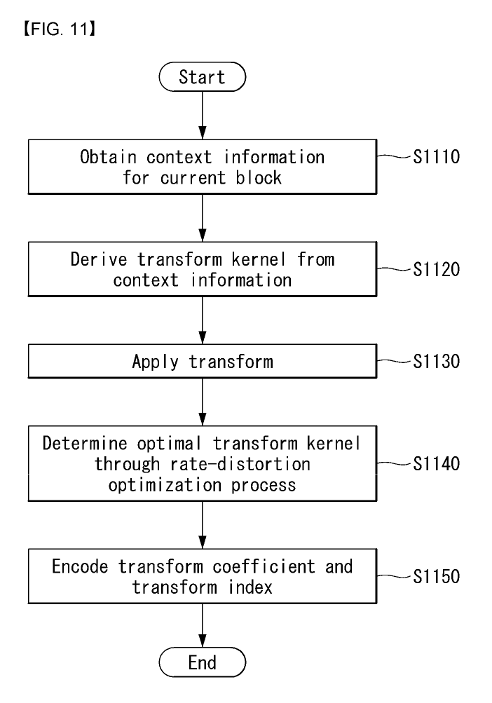

FIG. 11 is a flowchart for illustrating a method of performing transform using a graph generated based on a transform unit size (TU size) or a prediction mode as an embodiment to which the present invention is applied.

The present invention provides a method of generating a graph for deriving a graph-based transform applicable to an intra-coding.

The present invention provides a method of generating a graph for the entire block or a graph for a partial region in order to derive a graph-based transform applicable to an intra-coding.

The present invention provides a method of configuring a graph for the entire block from a dependency relation with neighboring reference pixels.

The present invention provides a method of configuring a partial graph from a graph for the entire block in order to derive a graph-based transform to be applied to a local region.

An embodiment of the present invention may generate a graph for a video block, may generate a Laplacian matrix from the graph, and may generate a transform kernel through Eigen-decomposition. The present invention may apply a transform kernel when a specific condition is satisfied within a transform unit within the encoder. In this case, the specific condition may mean a case corresponding to at least one of a transform unit size and an intra-prediction mode.

For another example, the encoder may determine a transform kernel that belongs to various transform kernels derived from a graph to which the present invention is applied and that has excellent performance in a rate-distortion aspect. The determined transform kernel may be transmitted to the decoder for each coding unit or transform unit, but the present invention is not limited thereto.

Furthermore, the encoder and the decoder may be already aware of an available transform kernel. In this case, the encoder may transmit only an index corresponding to the transform kernel.

Referring to FIG. 11, first, the encoder may obtain context information for a current block from an input video signal (S1110). In this case, the context information may mean information about a previously reconstructed sample.

The encoder may derive a transform kernel from the context information (S1120). For example, the transform kernel for the transform unit may be derived based on a prediction mode for the current block or a neighboring block.

The encoder may perform transform using the derived transform kernel (S1130), and may determine an optimal transform kernel through a rate-distortion optimization process if a plurality of transform types is present (S1140).

If the optimal transform kernel is determined, the encoder may encode a transform coefficient and a transform index (S1150). In this case, the transform index may mean a graph-based transform applied to a target block.

In an embodiment of the present invention, the transform index may be determined based on at least one of a prediction mode and the size of a transform unit. For example, the transform index may include different combinations based on at least one of the prediction mode and the size of the transform unit. That is, a different graph-based transform kernel may be applied based on the prediction mode or the size of the transform unit.

In another embodiment of the present invention, if a target block includes M or N subblocks partitioned in a horizontal direction or a vertical direction, the transform index may correspond to each subblock.

In another embodiment of the present invention, the graph-based transform is derived for each subblock based on a transform index, and a different transform type may be applied to at least two subblocks. For example, the different transform type may include at least two of discrete cosine transform (DCT), discrete sine transform (DST), asymmetric discrete sine transform (ADST) and reverse ADST (RADST).

In an embodiment of the present invention, the encoder may generate or design a line graph. In this case, the line graph may mean a graph for at least one line. For example, the encoder may generate one dimensional (1D) graph-based transform (GBT) associated with one line graph. In this case, the 1D graph-based transform (GBT) may be generated using a commercialized Laplacian operator.

Here, assuming that there are an adjacent matrix A and a graph G(A) defined thereof, the Laplacian matrix L may be obtained through Equation 5 below.

L=D−A+S [Equation 5]

In Equation 5 above, D represents a degree matrix, and for example, the degree matrix may mean a diagonal matrix that includes information of degree of each vertex. A represents an adjacency matrix that represents a connection relation (e.g., an edge) with an adjacent pixel as a weight. S represents a diagonal matrix that represents a self-loop in the nodes in G.

In addition, for the Laplacian matrix L, an optimal transform kernel can be obtained by performing an Eigen decomposition as represented in Equation 6 below.

L=U∧U^{T} [Equation 6]

In Equation 6 above, L means a Laplacian matrix L, U means an Eigen matrix, and U^{T} means a transposed matrix of U. In Equation 6, the Eigen matrix U may provide a graph-based Fourier transform specialized for a signal suitable for the corresponding model. For example, the Eigen matrix U that satisfies Equation 6 may mean a GBT kernel.

Here, the columns of the Eigen matrix U may mean basis vectors of the GBT. When a graph does not have a self-loop, a generalized Laplacian matrix is as represented as Equation 3 above.

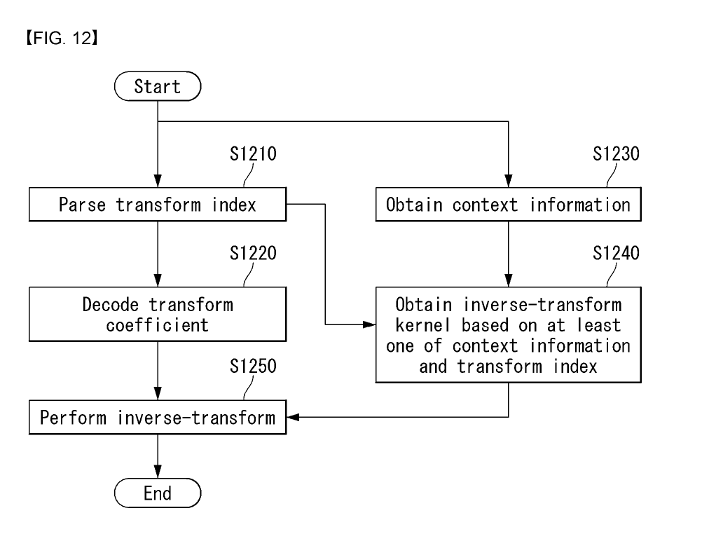

FIG. 12 is a flowchart for illustrating a method of performing an inverse transform using a graph generated based on a transform unit size (TU size) or a prediction mode as an embodiment to which the present invention is applied.

First, the decode may parse a transform index for a target block from a video signal (S1210). In this case, the transform index indicates a graph-based transform to be applied to the target block. For example, the graph-based transform to be applied to the target block may mean a graph-based transform kernel for at least one line. Step S1210 may be performed by the parsing unit within the decoder.

In an embodiment of the present invention, the transform index may be received every one unit of a coding unit, a prediction unit and a transform unit.

The encoder or the decoder to which the present invention is applied may be aware of various transform types. In this case, each transform type may be mapped to a transform index.

In an embodiment of the present invention, the transform index may be determined based on at least one of a prediction mode and the size of a transform unit. For example, the transform index may include a different combination based on at least one of the prediction mode and the size of a transform unit. That is, a different graph-based transform kernel may be applied based on the prediction mode or the size of a transform unit.

In another embodiment of the present invention, if a target block includes M or N subblocks partitioned in a horizontal direction or a vertical direction, the transform index may correspond to each subblocks.

In another embodiment of the present invention, the graph-based transform may be derived for each subblock based on the transform index, and a different transform type may be applied to at least two subblocks. For example, the different transform type may include at least two of DCT, DST, asymmetric discrete sine transform (ADST) and reverse ADST (RADST).

In another embodiment of the present invention, the graph-based transform may be a two-dimensional (2D)-separable graph-based transform kernel generated based on the coupling of a plurality of 1D graph-based transforms.

The decoder may decode a transform coefficient for the target block (S1220).

Meanwhile, the decoder may obtain context information (S1230). In this case, the context information may mean information about a previously reconstructed sample.

The decoder may obtain an inverse transform kernel based on at least one of the context information and the transform index (S1240). For example, the inverse transform kernel may be derived based on at least one of the prediction mode of the current block and the prediction mode of a neighboring block.

In an embodiment of the present invention, after a corresponding transform kernel is obtained based on a graph generated according to the present invention, a specific prediction mode may be substituted with another transform type. For example, if the specific prediction mode indicates an intra-vertical mode or an intra-horizontal mode, the transform kernel may be substituted with DCT or DST. For detailed example, the encoder and the decoder may be aware of all of transform kernels corresponding to 35 intra-prediction modes. Furthermore, a corresponding transform kernel may be applied to the prediction mode of an intra-coded block.

Furthermore, a transform kernel may be determined using both a transform index and context information.

The decoder may perform an inverse transform using the inverse transform kernel (S1250).

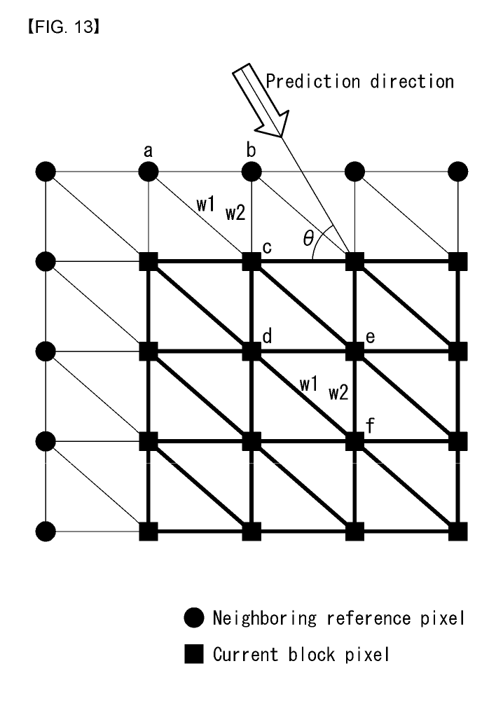

FIG. 13 is a pixel relation diagram for illustrating a method of predicting a current pixel using an edge weight according to a prediction direction in intra-prediction as an embodiment to which the present invention is applied.

In the case of an intra-coding, a current pixel value is predicted using a neighboring pixel value. Referring to FIG. 13, a, b, c, d, e, and f indicate pixel values at respective locations, and w1 and w2 indicate edge weights indicative of prediction contribution for pixel values located in each diagonal direction and each vertical direction. In this case, the edge weight may be defined based on a prediction direction according to a prediction mode. For example, the pixels c and f may be predicted based on Equation 7.

$$\hat{c} = \frac{aw 1 + bw 2}{w 1 + w 2} \\ \hat{f} = \frac{dw 1 + ew 2}{w 1 + w 2} \qquad [ Equation 7 ]$$

In this case, Ĉ and \hat{f} indicate prediction values of the respective pixels c and f.

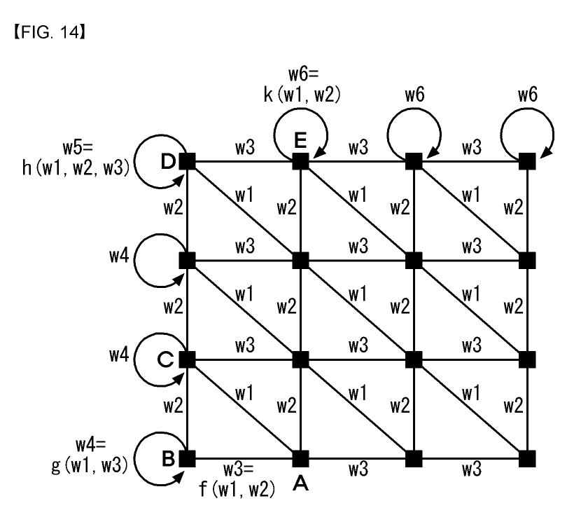

FIG. 14 is a diagram for illustrating a method of generating a graph using an edge weight according to an intra-prediction direction with respect to a 4×4 block as an embodiment to which the present invention is applied.

As described in FIG. 13, it may be seen that pixels have a dependency relation of w1 and w2 with respect to a diagonal direction and a vertical direction. FIG. 14 shows a graph for the pixels of a current block by incorporating such a dependency relation.

Referring to FIG. 14, a pixel B and a pixel C have a dependency relation of w2, and the pixel C and a pixel A have a dependency relation of w1. Accordingly, a dependency relation between the pixel A and the pixel B may be indicated as f(w1, w2), that is, the function of w1 and w2.

The pixel B is connected to two left reference pixels by an upper pixel (pixel C) as in FIG. 13, but the two left reference pixels are not shown in FIG. 14. Furthermore, the pixel B has been expressed as having the edge weight of w2 with respect to the pixel C. Accordingly, a connection relation for the two reference pixels not shown in FIG. 14 may be expressed by a self-loop.

In this case, a connection for the two left reference pixels not shown in FIG. 14 has the edge weights of w1 and w3, respectively. An edge weight for a self-loop connected to the pixel B may be indicated as g(w1, w3), that is, the function of w1 and w3.

Likewise, a self-loop may be applied to the pixel D and pixel E of FIG. 14. An edge weight for each self-loop may be indicated as a function h(w1, w2, w3) and a function k(w1, w2).

The embodiments of FIGS. 13 and 14 relate to an intra-prediction mode in which prediction is performed in a top down direction. In this specification, the embodiments are described, but the present invention is not limited thereto. For example, the functions f, g, h and k shown in FIG. 14 may have different functions based on a prediction direction or a prediction mode.

Furthermore, Equation 7 has been used to calculate edge weights, but this is only an embodiment and the present invention is not limited thereto. For example, in order to calculate w1 and w2, another value other than Equation 7 may be allocated. For detailed example, if graph edges overlap the boundary of objects, 0 or a positive value close to 0 may be applied to the edge weight values of the edges of FIG. 14.

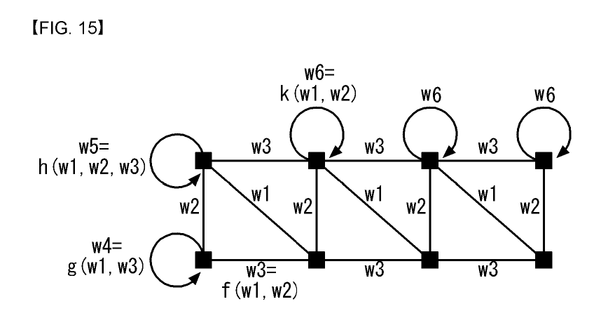

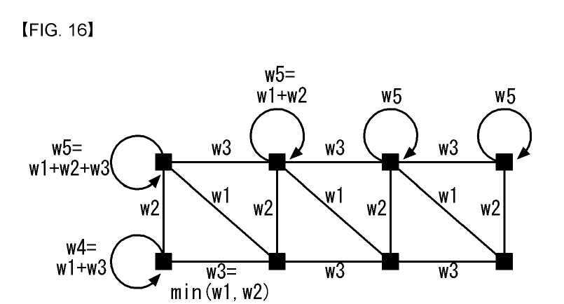

FIGS. 15 to 16 are diagrams for illustrating a method of generating a partial graph of a two-line unit using an edge weight according to an intra-prediction direction as embodiments to which the present invention is applied.

In an embodiment of the present invention, if transform is applied to the pixels of the current block of FIG. 13 in a two-line unit, a partial graph of a two-line unit may be generated in order to derive corresponding transform as in FIG. 15.

The graph of FIG. 14 may have been configured on the assumption that all of pixels forming the entire block has a dependency relation between consistent pixels with respect to the same prediction direction. If such an assumption is maintained, a partial graph for two lines, such as that of FIG. 15, may be configured like FIG. 14.

Referring to FIG. 15, functions f, g, h, and k may use the same function as described in FIG. 14 or may use different functions.

For example, if a graph-based transform is derived from a partial graph of FIG. 15 and applied to the entire block, a graph-based transform applied to every two lines may be sequentially applied.

FIG. 16 shows an embodiment in which various functions are applied to the graph of FIG. 15. For example, a function for selecting a minimum value of two edge weight values may be applied to a f function. A function of calculating the summation of edge weights may be applied to the remaining function h, function g, and function k.

This is expressed into Equation 8 as follows.

f=min(w1,w2)

g=w1+w3

h=w1+w2+w3

k=w1+w2 [Equation 8]

This corresponds to an embodiment of the present invention, and the present invention is not limited thereto. For example, a multiplication function (f=w1w2) of two edge weights or an average function (f=avg(w1, w2)) of two edge weights may be applied to w3 instead of a minimum value function.

In another embodiment, an edge weight function may be set based on a prediction direction angle, and an edge weight function, such as Equation 9 or Equation 10, may be used.

f=w1 cos θ [Equation 9]

f=(w1+w2)cos θ [Equation 10]

For example, as in FIG. 16, if an edge w1 and an edge w3 form an angle of 45 degrees, f=w1 cos(π/4) may be applied according to Equation 9.

Furthermore, assuming that precise prediction is performed from a prediction direction, a cos value of an angle formed by the prediction direction and a longitudinal axis may be considered to be prediction accuracy for a horizontal direction. Accordingly, Equation 10 may be applied.

Furthermore, the functions f, g, h, and k may be constant functions.

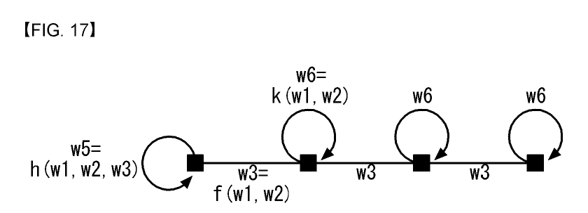

FIG. 17 is a diagram for illustrating a method of generating a partial graph of a one-line unit using an edge weight according to an intra-prediction direction as embodiments to which the present invention is applied.

FIG. 17 is an example in which a partial graph for one line has been configured from the graph of FIG. 14.

In this case, different functions may be applied to the functions f, h, and k of FIG. 17 as described above.

In this case, if a graph-based transform is derived from the partial graph of a 1-line unit of FIG. 17, it may be applied as 1D-separable transform with respect to the entire block.

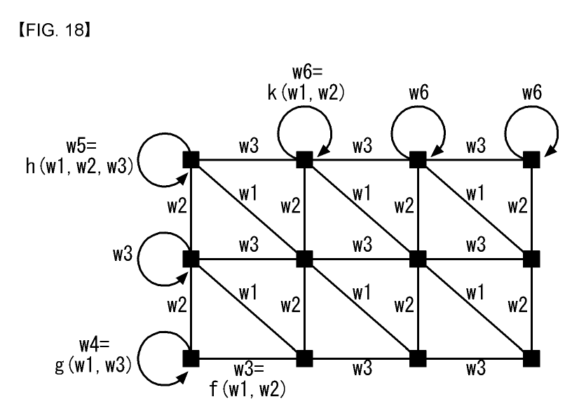

FIG. 18 is a diagram for illustrating a method of generating a partial graph of a three-line unit using an edge weight according to an intra-prediction direction as embodiments to which the present invention is applied.

The present embodiment shows a graph of a 3-line unit having an increased line compared to the partial graph of FIG. 15. Referring to FIG. 18, all of pixels A, B, C, D, E, and F have their self-loops, and the edge weights of the pixels are w5, w6, w6, w6, w3, and w4, respectively.

In this case, one of the various functions of the embodiments may be applied to edge weight functions f, g, h, and k, and the edge weight functions f, g, h, and k may be set differently from the functions of the aforementioned embodiments.

As described above, in the present invention, the embodiments of FIGS. 14 to 18 may be combined. In this case, a partial graph may be adaptively configured by freely increasing or decreasing the number of lines, and a different function may be applied to the edge weight of each pixel.

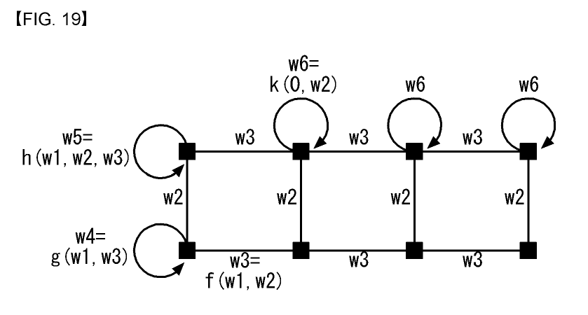

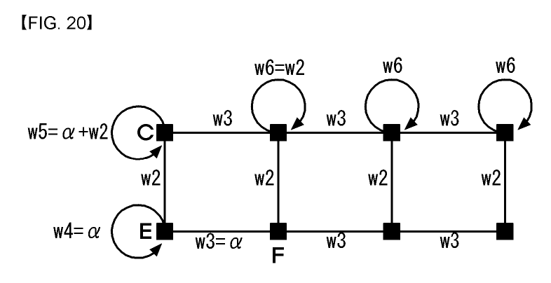

FIGS. 19 to 20 are diagrams for illustrating a method of generating a partial graph of a two-line unit using an edge weight according to a vertical direction in intra-prediction as embodiments to which the present invention is applied.

FIG. 19 shows a partial graph of a two-line unit if an intra-prediction mode indicates a vertical direction. In this case, w1 may be 0. Referring to FIG. 19, all of pixels A, B, C, D, and E have their self-loops, and the edge weights of the pixels are w5, w6, w6, w6, and w4, respectively. The edge weight functions may be indicated as in Equation 11.

w4=g(0,w3)

w5=h(0,w2,w3)

w6=k(0,w2) [Equation 11]

FIG. 20 shows an embodiment in which functions f, g, h and k have been set.

Referring to FIG. 20, the summation of edge weights of edges connected in a prediction direction has been set in each of the values w4, w5, and w6, and a constant value a has been set in w3.

Since there is no dependency relation between the pixel A and the pixel F, an edge weight between the pixel E and the pixel F cannot be derived.

Meanwhile, the value a may be obtained through statistical data. For example, the value a may indicate a correlation coefficient between two pixels.

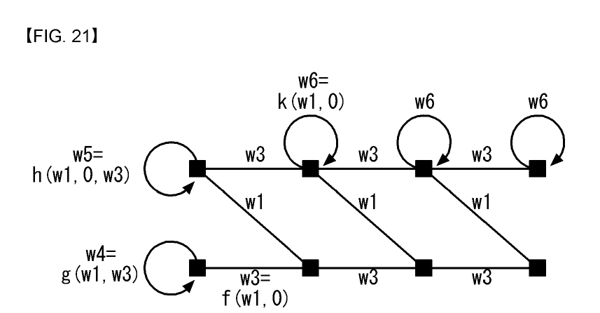

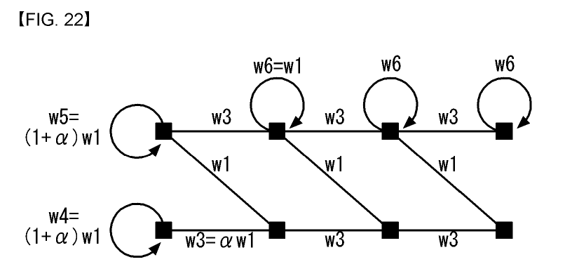

FIGS. 21 to 22 are diagram for illustrating a method of generating a partial graph of a two-line unit using an edge weight according to a bottom right direction in intra-prediction as embodiments to which the present invention is applied.

FIG. 21 shows a partial graph of a two-line unit if prediction is performed only in a bottom right direction only. In this case, w2=0 may be set.

Referring to FIG. 22, the summation of edge weights of edges connect in a prediction direction has been set in w4, w5, and w6. And the times a of a value w1 has been set in w3. In this case, the value a may be determined based on a prediction direction according to an intra-prediction mode. For example, in the case of FIG. 21, since the edge of w1 and the edge of w3 form an angle of π/4, cos(π/4) may be set. Alternatively, a constant value obtained from statistical data may be assigned to w3.

In the embodiments of FIGS. 14 to 22, the intra-prediction modes of a bottom right direction or a vertical direction have been described, but the present invention is not limited thereto. For example, a graph may be generated using the same method with respect to intra-prediction modes of a bottom left direction, a top right direction and a horizontal direction.

Furthermore, in the graph, at least one of the location of a self-loop, a diagonal edge direction, and a row/column line configuration may be different based on an intra-prediction mode.

For example, if an intra-prediction mode is predicted in the top right direction, a partial graph may be generated with respect to at least one column line.

Furthermore, the edge weight value may be determined based on a preset model or may be determined based on measurement for correlation coefficient between pixels through statistical data analysis.

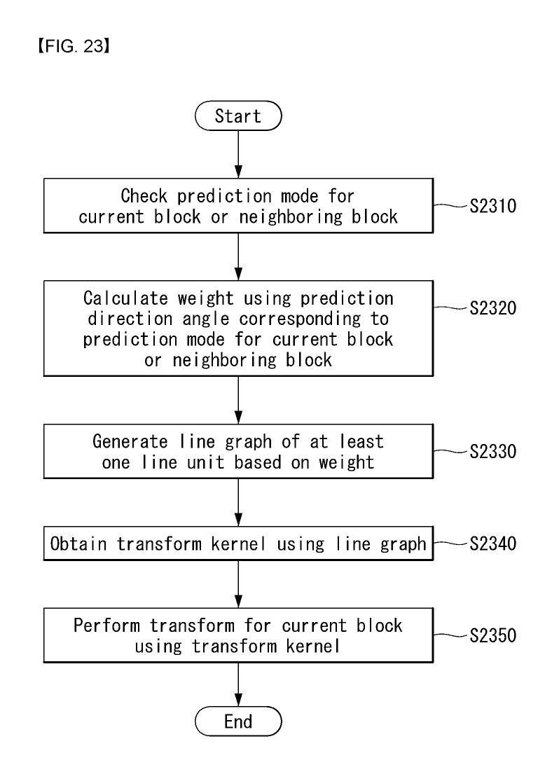

FIG. 23 is a flowchart for illustrating a method of calculating an edge weight according to a prediction mode and generating a line graph based on the edge weight as an embodiment to which the present invention is applied.

First, the encoder may check context information for a current block. For example, the context information may include a prediction mode of the current block or a prediction mode of a neighboring block (S2310).

The encoder may calculate the edge weight of an edge within the current block using a prediction direction angle corresponding to a prediction mode (S2320). The edge weight may be defined based on the prediction direction according to the prediction mode. For example, the edge weight may be predicted based on Equation 7, but the present invention is not limited thereto.

Furthermore, the edge weight may be calculated using various functions. For example, at least one of a function of selecting a minimum value of edge weight values, a function of calculating the summation of edge weights, a multiplication function of the edge weights, and an average function of the edge weights may be applied.

The encoder may generate a line graph of at least one line unit based on the edge weights (S2330). For example, if transform of a two-line unit is applied to the pixels of the current block, a partial graph of a two-line unit may be generated in order to derive corresponding transform.

The encoder may obtain a transform kernel for the generated line graph (S2340).

The encoder may perform transform for the current block using the transform kernel (S2350). In this case, if the transform kernel is derived from the partial graph of the two-line unit, a transform kernel corresponding to every two lines may be sequentially applied when it is applied to the entire block.

For another example, if one image is divided into several objects and coded, after a graph indicating a connection or disconnection between pixels is generated from location information or boundary information for each object, the transform kernel of each block may be obtained through the aforementioned GBT generation process. If one image is divided into several regions or objects through a segmentation algorithm, a graph may be constructed in such a way as to disconnect a corresponding connection of a graph between pixels belonging to different objects.

For another example, assuming that one image is coded in a CU or PU unit, the edge characteristics of the image may be approximately incorporated into the boundary of a CU or PU. Accordingly, if the boundary of a CU or PU is included in a TU, a graph may be configured by incorporating the corresponding boundary and the aforementioned GBT generation method may be applied. For example, if the boundary of a CU or PU is included in a TU, a connection for a portion where the boundary is met may be disconnected.

For another example, flag information indicating whether or not to apply GBT generated using the aforementioned method in various levels (e.g., a frame, slice, CU, PU or TU) may be defined, and optimal transform may be selected in at least one level. The encoder may apply both a common transform (e.g., DCT type-2 or DST type-7) and a graph-based transform (GBT) through a rate-distortion (RD) optimization process and designate transform having the lowest cost through a flag or index.

In this specification, a line graph having a total of vertexes has been described, but the present invention is not limited thereto. For example, the line graph may be extended to a line graph having the number of 8, 16, 32, 64 or more vertexes.

In the embodiments of the present invention, the line graph may be modeled for a prediction residual signal generated through an intra-prediction or an inter-prediction, and the optimal transform kernel may be selected adaptively according to the property of the prediction residual signal and used.

In the embodiments of the present invention, the transform kernel generated through each line graph may be selectively applied to a horizontal direction and a vertical direction using various combinations, and this may be signaled through additional information.

As described above, the embodiments explained in the present invention may be implemented and performed on a processor, a micro-processor, a controller or a chip. For example, functional modules explained in FIG. 1, FIG. 2, FIG. 8, FIG. 9 and FIG. 10 may be implemented and performed on a computer, a processor, a microprocessor, a controller or a chip.

As described above, the decoder and the encoder to which the present invention is applied may be included in a multimedia broadcasting transmission/reception apparatus, a mobile communication terminal, a home cinema video apparatus, a digital cinema video apparatus, a surveillance camera, a video chatting apparatus, a real-time communication apparatus, such as video communication, a mobile streaming apparatus, a storage medium, a camcorder, a VoD service providing apparatus, an Internet streaming service providing apparatus, a three-dimensional 3D video apparatus, a teleconference video apparatus, and a medical video apparatus and may be used to code video signals and data signals.

Furthermore, the decoding/encoding method to which the present invention is applied may be produced in the form of a program that is to be executed by a computer and may be stored in a computer-readable recording medium. Multimedia data having a data structure according to the present invention may also be stored in computer-readable recording media. The computer-readable recording media include all types of storage devices in which data readable by a computer system is stored. The computer-readable recording media may include a BD, a USB, ROM, RAM, CD-ROM, a magnetic tape, a floppy disk, and an optical data storage device, for example. Furthermore, the computer-readable recording media includes media implemented in the form of carrier waves, e.g., transmission through the Internet. Furthermore, a bit stream generated by the encoding method may be stored in a computer-readable recording medium or may be transmitted over wired/wireless communication networks.

### INDUSTRIAL APPLICABILITY

The exemplary embodiments of the present invention have been disclosed for illustrative purposes, and those skilled in the art may improve, change, replace, or add various other embodiments within the technical spirit and scope of the present invention disclosed in the attached claims

1. A method for encoding a video signal using a graph-based transform, comprising steps of:
checking context information for a current block, wherein the context information comprises a prediction mode for the current block or a neighboring block;
calculating an edge weight between pixels within the current block using a prediction direction angle corresponding to the prediction mode for the current block or the neighboring block;
deriving a transform kernel from a line graph generated based on the edge weight; and
performing transform for the current block using the transform kernel.

2. The method of claim 1, further comprising a step of encoding a transform index corresponding to the transform kernel.

3. The method of claim 1, wherein the edge weight is calculated using a weight function set based on the prediction mode or the prediction direction angle.

4. The method of claim 3, wherein:
the prediction direction angle indicates an angle formed by a prediction direction and a horizontal axis, and
the edge weight indicates a cosine value for the angle.

5. The method of claim 1, wherein the edge weight is calculated by at least one of a minimum value, summation, multiplication and an average value of connected edge weights.

6. The method of claim 1, wherein the line graph comprises a partial graph of at least one line unit.

7. The method of claim 6, wherein if the line graph indicates a partial graph of one line, the transform kernel indicates 1D separable graph-based transform corresponding to the line graph.

8. A method for decoding a video signal using a graph-based transform, comprising steps of:
parsing a transform index from the video signal;
obtaining context information for a target unit, wherein the context information comprises a prediction mode for a current block or a neighboring block;
obtaining an inverse transform kernel based on at least one of the transform index and the context information; and
performing an inverse transform on the current block using the inverse transform kernel.

9. The method of claim 8, wherein:
the inverse transform kernel has been generated based on a line graph expressed by an edge weight of the current block, and
the edge weight is calculated using a prediction direction angle corresponding to the prediction mode for the current block or the neighboring block.

10. The method of claim 9, wherein:
the prediction direction angle indicates an angle formed by a prediction direction and a horizontal axis, and
the edge weight indicates a cosine value for the angle.

11. The method of claim 9, wherein the edge weight is calculated by at least one of a minimum value, summation, multiplication and an average value of connected edge weights.

12. The method of claim 9, wherein the line graph comprises a partial graph of at least one line unit.

13. The method of claim 12, wherein if the line graph indicates a partial graph of one line, the transform kernel indicates 1D separable graph-based transform corresponding to the line graph.

14. An apparatus for encoding a video signal using a graph-based transform, comprising:
a graph signal generation unit checking context information for a current block and calculating an edge weight between pixels within the current block using a prediction direction angle corresponding to the prediction mode for the current block or the neighboring block;
a transform matrix determination unit deriving a transform kernel from a line graph generated based on the edge weight; and
a transform execution unit performing transform for the current block using the transform kernel,
wherein the context information comprises a prediction mode for the current block or a neighboring block.

15. An apparatus for decoding a video signal using a graph-based transform, comprising:
a parsing unit parsing a transform index from the video signal; and
an inverse transform unit obtaining context information for a target unit, obtaining an inverse transform kernel based on at least one of the transform index and the context information, and performing an inverse transform on the current block using the inverse transform kernel,
wherein the context information comprises a prediction mode for a current block or a neighboring block.
